(19) United States
(12) Patent Application Publication
(10) Pub. No.: US 2004/0151412 A1
(43) Pub. Date: Aug. 5, 2004

(54) Sleeve with improved adhering properties, and radial bearing including such a sleeve

(75) Inventor: Bernd Helm, Markt Taschendorf (DE)

Correspondence Address: HENRY M FEIEREISEN, LLC, 350 FIFTH AVENUE, SUITE 4714, NEW YORK, NY, 10118, US

(73) Assignee: INA-SCHAEFFLER KG, Herzogenaurach (DE)

(21) Appl. No.: 10/734,745

(22) Filed: Dec. 12, 2003

(30) Foreign Application Priority Data
Dec. 13, 2002 (DE) 102 58 241.6

(51) Int. Cl. F16C 33/62; F16C 33/32

(52) U.S. Cl. 384/492

(57) ABSTRACT

A radial bearing disposed between transmission parts moving in opposition to one another at different speed, includes an inner sleeve for attachment to one transmission part and an outer sleeve; for attachment to another transmission part. Disposed between the inner sleeve and the outer sleeve is a plurality of rolling bodies. At least one of the inner sleeve and the outer sleeve is provided with a coating which contains ZnNi or ZNFe and is applied galvanically onto the inner sleeve and/or outer sleeve before attachment to the respective transmission part.

### CROSS-REFERENCES TO RELATED APPLICATIONS

This application claims the priority of German Patent Application, Serial No. 102 58 241.6, filed Dec. 13, 2002, pursuant to 35 U.S.C. 119(a)-(d), the disclosure of which is incorporated herein by reference.

### BACKGROUND OF THE INVENTION

The present invention relates to a sleeve with improved adhering properties, and more particularly to a radial bearing provided with such a sleeve.

In general, a radial bearing includes an inner sleeve and an outer sleeve with rolling bodies disposed therebetween. It is generally known, to secure the inner sleeve and the outer sleeve to respective transmission parts in such a manner that the sleeve is securely held in axial direction and in circumferential direction, irrespective of the load on the bearing.

German patent publication DE 43 32 028 A1 discloses a radial bearing in the form of a pressure fluid operated bearing whereby the pressure fluid is conducted through an opening in the inner sleeve, through the bearing, through a further opening in the outer sleeve into a transmission part, or in reverse flow direction. As the openings in the inner and outer sleeves are part of the passageway for conduction of the pressure fluid, it is important that the sleeves are restrained in the respective transmission parts against movement in axial direction and against rotation. Despite the press-fit disposition of the sleeves on or in the transmission parts, a firm seat of the sleeves of this conventional radial bearing cannot be ensured, so that considerable damage or faulty controls of the transmission may be encountered.

The publication “Galvanotechnik” [galvanotechniques”, No. 12, December 1993, describes the use of a galvanized plating, called Corrotect®, on bearing surfaces for protecting the bearing surfaces against rust.

It would therefore be desirable and advantageous to provide an improved radial bearing to obviate prior art shortcomings and to ensure secure fit of the inner and/or outer sleeves to the transmission parts while still being simple and cost-efficient in structure, without the need for clamps, screws or the like.

### SUMMARY OF THE INVENTION

According to one aspect of the present invention, a radial bearing disposed between transmission parts moving in opposition to one another at different speed, includes an inner sleeve for attachment to one transmission part, an outer sleeve; for attachment to another transmission part, plural rolling bodies disposed between the inner sleeve and the outer sleeve, wherein at least one member selected from the group consisting of the inner sleeve and the outer sleeve is provided with a coating which contains ZnNi or ZnFe and is applied galvanically onto the member before attachment to the respective transmission part.

The present invention resolves prior art shortcomings by recognizing the superior adhesion capability of a coating which contains ZnNi or ZNFe for use in the attachment of a sleeve to a transmission part, regardless whether the respective components are to be secured within one another or in superimposed disposition. A sleeve coated in this way exhibits superior adhesion capability to ensure a firm seat of the sleeve in or upon the transmission part. The realization of a firm seat is especially relevant when the inner sleeve and/or outer sleeve is part of a pressure fluid operated radial bearing which is disposed in a transmission that is controlled by pressure fluid and has transmission parts in the form of a carrier element and a clutch drum. Hereby, the inner sleeve and/or the outer sleeve has or have openings for passage of the pressure medium from and to bores in the carrier element and the clutch drum.

According to another feature of the present invention, the sleeves are disposed by means of a press fit upon or in the transmission part to enhance the secure attachment. A firm seat is ensured, even when the sleeves are made of conventional roller bearing steels, by making the transmission parts, interacting with the sleeves, of cast iron material.

According to another aspect of the present invention, a sleeve has an outer surface which is provided with a coating containing ZnNi or ZnFe and applied galvanically on the outer surface for providing adhesive properties for attachment to a component.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a longitudinal section of a transmission operated by pressure medium and having incorporated a radial bearing according to the present invention; and

FIG. 1a is an enlarged detailed view of the area encircled in FIG. 1.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

For sake of simplicity, the following description will refer to inner and outer sleeves of radial bearings, as shown by way of example in the drawing, but it will be understood by persons skilled in the art, that the present invention should is applicable for any type of sleeves.

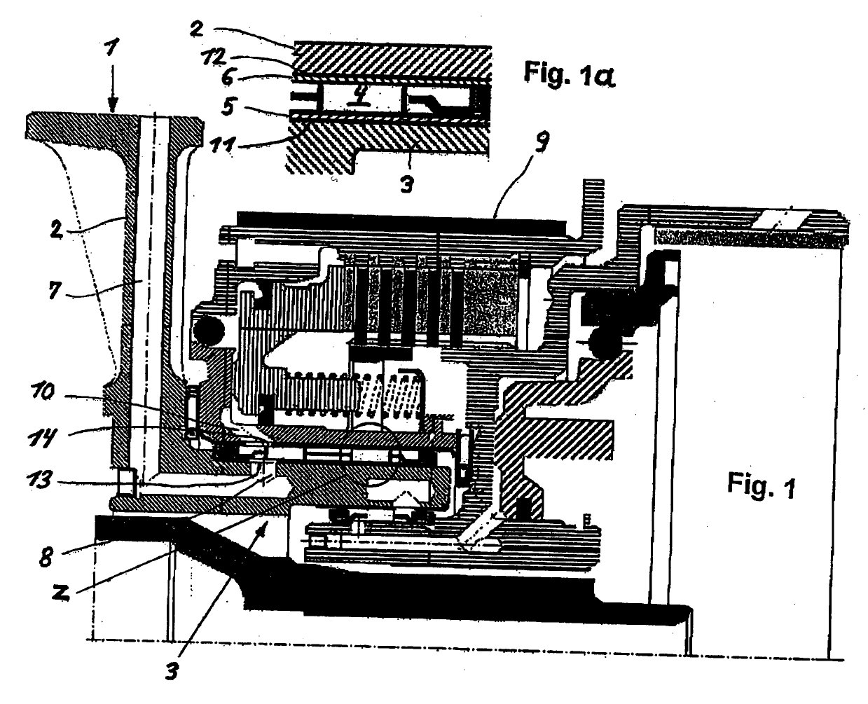

Turning now to FIG. 1, there is shown a longitudinal section of a transmission including a carrier element, generally designated by reference numeral 1 and having an attachment arm 2 and a cylindrical body 3. Disposed on the outer surface of the cylinder body 3 is a radial bearing 4 having an inner sleeve 5 and an outer sleeve 6, as shown in particular in FIG. 1a which is an enlarged detailed view of an area Z encircled in FIG. 1. Arranged between the inner and outer sleeves 5, 6 are plural rolling bodies, a rolling body cage and seals in a manner generally known per se.

Provided in the attachment arm 2 and the cylinder body 3 is a pressure medium bore 7 which is fluidly connected via openings 8 with corresponding bores 13 of the inner sleeve 5 to thereby interact with the radial bearing 4. The outer sleeve 6 is fitted in a clutch drum 9 which has an interior for accommodating a piston 11 and a plurality of clutch disks 12 which are acted upon by the piston 11. The outer sleeve 6 has an opening 14 which is fluidly connected to a pressure medium bore 10 in the clutch drum 9 for conducting pressure medium to the piston 11 in the clutch drum 9.

As shown in particular in FIG. 1a, in order to ensure a firm seat of the inner sleeve 5 upon the cylinder body 2 and of the outer sleeve 6 in the clutch drum 9, the inner sleeve 5 is galvanically plated with a coating 11, and the outer sleeve 6 is galvanically plated with a coating 12, whereby each of the coatings 11, 12 contains ZnNi or ZnFe. Thus, the inner and outer sleeves 5, 6 are restrained against carrying out an axial movement and restrained against rotation.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A radial bearing disposed between transmission parts moving in opposition to one another at different speed, comprising:
an inner sleeve for attachment to one transmission part;
an outer sleeve; for attachment to another transmission part;
plural rolling bodies disposed between the inner sleeve and the outer sleeve, wherein at least one member selected from the group consisting of the inner sleeve and the outer sleeve is provided with a coating which contains ZnNi or ZNFe and is applied galvanically onto the member before attachment to the respective transmission part.

2. The radial bearing of claim 1 operated by a pressure medium, wherein the member has openings for passage of the pressure medium to a pressure medium feed bore in one of the transmission parts and a pressure medium bore in the other one of the transmission parts.

3. The radial bearing of claim 1, wherein the member is placed by means of a press-fit in the respective transmission part.

4. The radial bearing of claim 1, wherein the transmission part interacting with the outer sleeve is made of a cast iron material.

5. A sleeve having an outer surface provided with a coating containing ZnNi or ZnFe and applied galvanically on the outer surface for providing adhesive properties for attachment to a component.
